(19) United States
(12) Patent Application Publication
(10) Pub. No.: US 2015/0294255 A1
(43) Pub. Date: Oct. 15, 2015

(54) PERFORMANCE ANALYSIS OF ORGANIZATIONAL PROGRAMS

(71) Applicant: Tata Consultancy Services Limited, Mumbai (IN)

(72) Inventors: Syed Wasiulla Hussaini, Hyderabad (IN); Supriya Kummamuru, Hyderabad (IN); Narayana Guru Prasada Lakshmi Mandaleeka, Hyderabad (IN)

(73) Assignee: Tata Consultancy Services Limited, Mumbai (IN)

(21) Appl. No.: 14/251,219

(22) Filed: Apr. 11, 2014

(51) Int. Cl. G06Q 10/06

(52) U.S. Cl. CPC G06Q 10/06393

(57) ABSTRACT

The present subject matter relates to performance evaluation, and in particular, relates to a parameter-based performance analysis of an organizational program. The method comprises receiving program specification associated with the organizational program. Further, a set of performance parameters may be selected from among a plurality of performance parameters being provided to a user. The plurality of performance parameters pertain to an analysis category. Further, a parameter score for the organizational program, with regard to each of the set of performance parameters, may be determined, based on predefined scoring criteria of the organizational program pertaining to the corresponding performance parameter. Subsequently, an overall performance index may be ascertained by consolidating the parameter score corresponding to each of the set of performance parameters, based on a weight assigned to each performance parameter. The organizational program can be updated, based on at least one of the parameter score and the overall performance index.

### TECHNICAL FIELD

The present subject matter relates, in general, to performance analysis and, particularly but not exclusively, to a parameter-based performance analysis of organizational programs.

### BACKGROUND

Generally, organizations handle a large number of programs simultaneously. Such programs can also be referred to as organizational programs, and may include multiple projects to achieve specific objectives in an organization. Examples of such programs include, but are not limited to educational programs, employment schemes, and consumer awareness schemes and programs. As would be understood, successful execution and completion of such programs may eventually assist in carving a path of growth and development for an organization. However, there may be numerous factors, which can affect the progress of a program at different stages. For instance, as scope and complexity of the program increase, the challenges witnessed during the execution of program may also increase. Therefore, organizations invest significant resources to monitor and assess the performance of the program in order to ensure that the program yields a productive outcome with optimum utilization of resources available.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a network environment implementing a performance analysis system, in accordance with an embodiment of the present subject matter.

FIG. 2 illustrates a method for a parameter-based performance analysis of an organizational program, in accordance with an embodiment of the present subject matter.

### DETAILED DESCRIPTION

System(s) and method(s) for a parameter-based performance analysis of an organizational program are described. The system(s) and method(s) can be implemented in a variety of computing devices, such as laptops, desktops, workstations, tablet-PCs, notebooks, portable computers, tablet computers, internet appliances, and similar systems. However, a person skilled in the art will comprehend that the embodiments of the present subject matter are not limited to any particular computing system, architecture, or application device, as they may be adapted to new computing systems and platforms as they become available.

In recent times, commercialization across the globe has resulted into a highly competitive environment for organizations. Usually, organizations, e.g., government organizations, non-government organizations and business organizations, handle a large number of programs at one time. As is generally understood, a program may include a series of related and possibly interdependent projects that, in entirety, achieve a comprehensive objective. The scope and extent of a program may vary based on the requirements of the organization and consumers. Such programs may include, but are not limited to a census program, a healthcare program, a literacy program, a financial scheme program and an employment program. Typically, organizations invest huge resources in order to ensure a successful completion of such programs.

From an organization's perspective, any negligence towards the execution of a program may not be affordable as such negligence may eventually affect an overall growth and development of the organization. On the other hand, from the consumer's perspective, failure of programs may leave an adverse impact on the society as well. For example, failure of a healthcare program may affect the society by depriving the consumers of healthcare benefits. Therefore, organizations generally monitor on-going developments in a program to ensure that the program is following an expected course of action. In order to exercise such monitoring, the organizations may opt for a number of techniques for monitoring and assessing the performance of a program. For example, the organization may identify and monitor various factors associated with the program which can affect the program during the course of execution and implementation, say based on the nature of a program and the corresponding industry. However, owing to the involvement of a large number of factors and dynamicity associated with such factors, monitoring of programs may come across as a challenge. Accordingly, the dynamic nature of the factors may cause an undesirable uncertainty about the success of a program.

Further, the conventional techniques typically offer a generic approach, and may not take into account industry-specific factors for the assessment of the performance of a program. Also, based on the requirements and the nature of a program, each factor may possess different relevance, in term of its impact on the progress of the program, at different stages of the program. For example, a factor may not affect the progress of a program at initial stages but may prove to be critical at later stages of the program. The conventional techniques may not consider such dynamicity associated with the factors for the analysis. Therefore, the conventional techniques offer a fragmented approach for the assessment of performance of a program.

Further, owing to the lack of knowledge of the industry-specific factors and their corresponding relevance to the program, the accuracy and reliability of the assessment may also be compromised. In addition, in absence of an accurate and reliable technique for the assessment, wastage of resources may occur, leading to an increase in the overall cost of running the program in turn. Thus, as is evident, the conventional techniques offer a fragmented, inaccurate, expensive, and inefficient proposition for assessing the performance of a program.

According to the present subject matter, a performance analysis system, hereinafter referred to as a system, for a parameter-based analysis of a program, interchangeably referred to as organizational program, for performance evaluation is disclosed. An organizational program may be understood as a program handled by an organization, which may include multiple projects to achieve specific objectives in the organization. In one implementation, the system may receive program specification associated with the program to be analyzed for performance evaluation. Once the program specification may be received, a set of performance parameters may be selected from among a plurality of performance parameters being provided to a user. The plurality of performance parameters may pertain to an analysis category. The analysis category is indicative of at least one of leadership, strategy, planning, a customer, market research, knowledge management, human resource and deliverables associated with the program. The system may determine a parameter score, with regard to each of the set of performance parameters, for the program. Following the determination, the parameter score corresponding to each of the set of performance parameters may be consolidated, based on a weight assigned to each performance parameter, to compute an overall performance index for the program. In one implementation, the program may be updated based on at least one of the parameter scores and the overall performance index of the program.

In one implementation, the program to be analyzed for the performance evaluation may include, but is not limited to an employment program, a literacy program, an education program, a consumer awareness program, a financial scheme program, a census program, a healthcare program and a voting program. Each program can further be disintegrated into a plurality of small-scale projects. For example, an employment program may include projects such as advertising, public awareness, candidate enrollment and financial aspect. Further, the program specification may be understood as functional and operational details associated with the program. In one implementation, the program specification may include, but is not limited to timelines, milestones, objectives, statistics, resources and field of the program.

In one implementation, the analysis categories may include, but are not limited to a leadership category, a Strategy and Planning (SP) category, a Customer and Market (CM) category, a Measurement Analysis and Knowledge Management (MAKM) category, a Human Resource (HR) category, and a Process and Deliverables (PD) category. As the name suggests, the leadership category may be understood as a category of performance parameters, which pertain to a leadership aspect of the program.

Similarly, the SP category may be understood as a category of performance parameters, which pertain to strategy and planning associated with the program. Further, the CM category may be understood as a category of performance parameters, which pertain to expectations of market and consumers associated with the project. Similarly, the MAKM category may be understood as a category of performance parameters, which pertain to knowledge management associated with the program. In one implementation, the HR category may be understood as a category of performance parameters, which pertain to human resource associated with the program. Further, the PD category may be understood as a category of performance parameters, which pertain to process and deliverables associated with the program.

In one implementation, the plurality of performance parameters may be provided to the user. The user may select the set of performance parameters based on which, the user wishes to evaluate the performance of the program. Subsequent to the selection of the set of performance parameters, the system may determine a parameter score, with regard to each of the set of performance parameters, for the program. The parameter score may be determined based on scoring criteria of the program pertaining to each of the set of performance parameters. The scoring criteria may be understood as available information of the program pertaining to the set of performance parameters. For example, for the performance parameter “Number of customer complaints”, the system may determine a parameter score based on the number of customer complaints being registered against the program. Similarly, for the performance parameter “Are the objectives of the program correctly communicated to team members?”, the system may determine a parameter score based on the number of program awareness sessions conducted by team leaders to familiarize the team members with the program.

In one implementation, in continuation with the determination of the parameter scores, the system may consolidate the parameter scores corresponding to the set of performance parameters to determine one or more category scores. For example, parameter scores corresponding to performance parameters of the leadership category may be combined to determine a leadership category score for the program. The category scores can then further be consolidated to ascertain the overall performance index for the program. In one implementation, the parameter scores may be consolidated based on pre-defined weights assigned to each performance parameter. In another implementation, instead of the performance parameters, each analysis category may be assigned a weight for ascertaining the overall performance index. A weight assigned to a performance parameter or an analysis category may be indicative of a weightage of the performance parameter or the analysis category in the evaluation of the overall performance index of the program. In one implementation, the weights to be assigned to the analysis categories or the performance parameters may vary based on the industry the program belongs to, nature of the program and user preference.

In one implementation, the system may compute the overall performance index on a scale of 1-1000. Further, each performance parameter or an analysis category may be assigned a weight in the form of percentage of the maximum score of 1000. In one implementation, the performance of the program may be evaluated on a scale of 0-250 for the leadership category. Similarly, for the SP category, the CM category, the MAKP category, the HR category and the PD category, the performance of the program may be evaluated on a scale of 0-250, 0-150, 0-100, 0-150 and 0-100, respectively. Further, a parameter score for a performance parameter may be allotted on a scale of, e.g., 0-10, 0-30 or 0-45, based on a corresponding weight of the performance parameter. Continuing with the present implementation, a program with an overall performance index of 0-450 may considered to be “Poor”. Similarly, a program with an overall performance index of 451-750 and 751-1000 may considered to be “Average” and “Good”, respectively. In one implementation, programs with an overall performance index of 0-450, 451-750 and 751-1000 may be given a color code “Red”, “Amber” and “Green”, respectively.

Following the ascertaining of the overall performance index, the system may generate a performance evaluation report for the program. As the name suggests, the performance evaluation report is indicative of the analysis of the program for the performance evaluation, and may include, but is not limited to the parameter scores, the category scores, the overall performance index, areas of improvement and suggestions to improve the performance of the program. In one implementation, based on the performance evaluation report, an administrator may update the execution of the program. The administrator may be understood as a person having the authority of taking managerial decisions for the program.

As would be gathered, the analysis categories cover all the aspects of program execution. In fact, the program can be monitored and evaluated for various facets of the program execution, which may come into action at different stages of the program. Further, the weights assigned to different analysis categories and the performance parameters ensure that varying relevance of analysis categories and the performance parameters for different programs can be taken into account for the analysis. Therefore, industry-specific performance parameters can also be considered for the program performance analysis. This would lead to a comprehensive analysis of the program for the evaluation of the performance. Also, accuracy of the analysis can also be ensured as the program can be evaluated for a broad spectrum of performance parameters. All the above-mentioned advantages lead to an optimum utilization of time and resources, which would facilitate in reducing the cost involved as well. Therefore, the performance evaluation system of the present subject matter provides a comprehensive and exhaustive approach for a time-saving, accurate, and inexpensive performance evaluation analysis.

These and other advantages of the present subject matter would be described in greater detail in conjunction with the following figures. While aspects of described system(s) and method(s) for analysis of an organizational program for the performance evaluation can be implemented in any number of different computing systems, environments, and/or configurations, the embodiments are described in the context of the following exemplary system(s).

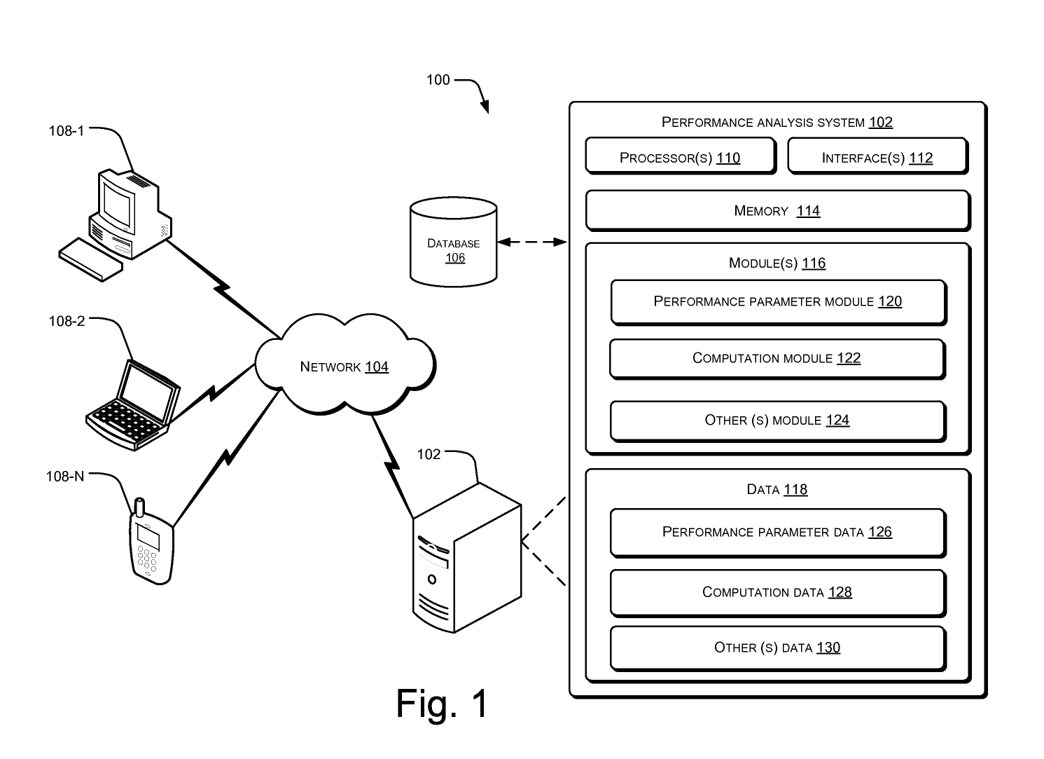

FIG. 1 illustrates a network environment 100 implementing a performance analysis system 102, also referred to as system 102, according to an embodiment of the present subject matter. In the network environment 100, the system 102 is connected to a network 104. Further, the system 102 is connected to a database 106. Additionally, the network environment 100 includes one or more user devices 108-1, 108-2 . . . 108-N, collectively referred to as user devices 108 and individually referred to as user device 108, connected to the network 104.

The system 102 can be implemented as any set of computing devices connected to the network 104. For instance, the system 102 may be implemented as workstations, personal computers, desktop computers, multiprocessor systems, laptops, network computers, minicomputers, servers, and the like. In addition, the system 102 may include multiple servers to perform mirrored tasks for users.

Furthermore, the system 102 can be connected to the user devices 108 through the network 104. Examples of the user devices 108 include, but are not limited to personal computers, desktop computers, smart phones, PDAs, and laptops. Communication links between the user devices 108 and the system 102 are enabled through various forms of connections, for example, via dial-up modem connections, cable links, digital subscriber lines (DSL), wireless or satellite links, or any other suitable form of communication.

Moreover, the network 104 may be a wireless network, a wired network, or a combination thereof. The network 104 can also be an individual network or a collection of many such individual networks interconnected with each other and functioning as a single large network, e.g., the internet or an intranet. The network 104 can be implemented as one of the different types of networks, such as intranet, local area network (LAN), wide area network (WAN), the internet, and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 104 may include network devices, such as network switches, hubs, routers, host bus adapters (HBAs), for providing a link between the system 102 and the user devices 108. The network devices within the network 104 may interact with the system 102 and the user devices 108 through communication links.

In said embodiment, the system 102 includes one or more processor(s) 110, interface(s) 112, and a memory 114 coupled to the processor 110. The processor 110 can be a single processing unit or a number of units, all of which could also include multiple computing units. The processor 110 may be implemented as one or more microprocessors, microcomputers, microcontrollers, digital signal processors, central processing units, state machines, logic circuitries, and/or any devices that manipulate signals based on operational instructions. Among other capabilities, the processor 110 is configured to fetch and execute computer-readable instructions and data stored in the memory 114.

The interfaces 112 may include a variety of software and hardware interfaces, for example, interface for peripheral device(s), such as a keyboard, a mouse, an external memory, and a printer. Further, the interfaces 112 may enable the system 102 to communicate with other computing devices, such as web servers, and external data repositories, such as the database 106, in the network environment 100. The interfaces 112 may facilitate multiple communications within a wide variety of protocols and networks, such as the network 104, including wired networks, e.g., LAN, cable, etc., and wireless networks, e.g., WLAN, cellular, satellite, etc. The interfaces 112 may include one or more ports for connecting the system 102 to a number of computing devices.

The memory 114 may include any non-transitory computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The non-transitory computer-readable medium, however, excludes a transitory, propagating signal.

The system 102 also includes module(s) 116 and data 118. The module(s) 116 include routines, programs, objects, components, data structures, etc., which perform particular tasks or implement particular abstract data types. In one implementation, the module(s) 116 include a performance parameter module 120, a computation module 122 and other module(s) 124. The other module(s) 124 may include programs or coded instructions that supplement applications and functions of the system 102.

On the other hand, the data 118 inter alia serves as a repository for storing data processed, received, and generated by one or more of the module(s) 116. The data 118 includes, for example, performance parameter data 126, computation data 128, and other data 130. The other data 130 includes data generated as a result of the execution of one or more modules in the module(s) 116.

The system 102 may analyze a program for performance evaluation. The program may be understood as an organizational program including multiple projects, and directed towards achieving specific objectives in an organization. In one implementation, the performance parameter module 120 may receive program specification associated with a program to be analyzed for evaluating the performance. The program specification may be understood as operational and functional characteristics associated with the program. In one implementation, the program specification may include, but is not limited to timelines, milestones, objectives, statistics, resources, and field of the program. Further, the program may include, but is not limited to an employment program, a literacy program, an education program, a consumer awareness program, a financial scheme program, a census program, a healthcare program and a voting program. The program may further be divided into multiple projects. For example, a healthcare program may include projects, such as patient registration, staff recruitment, medicine inventory, finances and regular check-up schedule management. In another example, in case of a financial scheme program being employed in a bank, the project may include retail banking, investment banking, commercial banking and online banking Successful execution and coordination of such projects may eventually lead to a successful execution and completion of a program.

In one implementation, following the receipt of the program, the performance parameter module 120 may provide a plurality of performance parameters to a user. A performance parameter may be understood as a factor that may affect an overall performance of the program. The plurality of performance parameters may further be categorized into multiple analysis categories. In one implementation, the multiple analysis categories may include, but are not limited to a leadership category, a Strategic Planning (SP) category, a Customer and Market (CM) category, a Measurement Analysis and Knowledge Management (MAKM) category, a Human Resource (HR) category, and a Process and Deliverables (PD) category.

In one implementation, the leadership category is indicative of a category of performance parameters, which relate to a leadership aspect associated with the program. For example, the performance parameters of the leadership category may include “Are the Vision, Mission and Values (VMV) of the program clearly defined?”, “Are the objectives of the program correctly communicated to team members?”, “Number of program awareness sessions conducted by team leaders”, “Number of quality checks to be performed” and “Number of unresolved issues pertaining to the execution of the project”.

Similarly, the SP category is indicative of a category of performance parameters, which relate to a strategy and planning aspect of the program. For example, the performance parameters of the SP category may include “Percentage of benefits delivered as promised by the program”, “Percentage of projects on hold”, “Number of stakeholders”, and “Percentage of stakeholder's expectations being managed efficiently”. Further, the CM category is indicative of a category of performance parameters, which relate to expectations of market and consumers associated with the program. For example, the performance parameters of the CM category may include “Number of customer complaints”, “Number of customer related projects facing critical problems”, and “Number of appreciation letters received from customers”. Similarly, the MAKM category is indicative of a category of performance parameters, which relate to a knowledge management aspect of the program. For example, the performance parameters of the MAKM category may include “Number of improvement initiatives undertaken in the program”, “Number of best practices adopted in the program” and “Number of knowledge assessment assets created”. In one implementation, the HR category is indicative of a category of performance parameters, which relate to a human resource aspect of the program. For example, the performance parameters of the HR category may include “Percentage of team members with one or more professional or technical certifications” and “Average training days per team member in the program”. Further, the PD category is indicative of a category of performance parameters, which relate to process and deliverables associated with the program. For example, the performance parameters of the PD category may include “Percentage of products being delivered within timeline”, “Response time for troubleshooting” and “Percentage of products being delivered within budget”.

Subsequent to providing the plurality of performance parameters, the performance parameter module 120 may obtain a set of performance parameters as user's selection. The set of performance parameters may be understood as one or more performance parameters based on which, the user wishes to evaluate the performance of the program. The user may select the set of performance parameters, based on the industry the program belongs to, historical records, and previous cycles of performance analysis of similar programs. In one implementation, instead of the user, the performance parameter module 120 may select the set of performance parameters, based on the industry the program belongs to, historical records and previous cycles of performance analysis of similar programs. In one implementation, the details pertaining to the performance parameter module 120 may be stored in the performance parameter data 126.

In one implementation, the computation module 122 may determine a parameter score for the program, for each of the set of performance parameters. In one implementation, the computation module 122 may determine the parameter score based on scoring criteria, with regard to the corresponding performance parameter, of the program. The scoring criteria are indicative of information of the program pertaining to the corresponding performance parameter. For example, for the performance parameter “Number of customer complaints”, the computation module 122 may determine a parameter score to the program, based on the number of customer complaints being registered against the program. Similarly, for the performance parameter “Number of appreciation letters received from the customers”, the computation module 122 may determine a parameter score based on the feedback received from the customers. In one implementation, for different programs, the plurality of performance parameters may vary based on nature of the program, industry the program belongs to, and user's preference. However, the analysis categories to be utilized for evaluating the performance of the program may remain same as mentioned above. For example, industry-specific performance parameters can be taken into account for the performance evaluation.

Once the parameter scores corresponding to each of the set of performance parameters may be determined, the computation module 122 may consolidate the parameter scores to ascertain an overall performance index for the program. The overall performance index is indicative of an overall performance of the program. In one implementation, the computation module 122 may consolidate the parameter scores, based on a pre-defined weight of each of the set of performance parameters. In another implementation, rather than assigning weight to each of the set of performance parameters, the computation module 122 may assign a weight to each of the analysis categories. In such an implementation, the computation module 122 may consolidate the parameter scores, based on the weights assigned to the analysis categories. A weight of a performance parameter or an analysis category is indicative of weightage of the performance parameter or the analysis category for performance evaluation of a program.

In one implementation, the computation module 122 may assign the weight to each of the set of performance parameters or the analysis categories, based on a user preference. In another implementation, the computation module 122 may assign weights, based on historical records, e.g., previous cycles of performance evaluation for similar programs.

Following the ascertaining of the overall performance index, the computation module 122 may generate a performance evaluation report being indicative of the analysis of the program. In one implementation, the performance evaluation report may include, but is not limited to the parameter scores, the overall performance index, areas of improvement and suggestions to improve an overall performance of the program. Further, based on the performance evaluation report, the program may be updated. In one implementation, an administrator may update the program based on the performance evaluation report. The administrator may be understood as a person having the authority of taking managerial decisions for the program. For example, in case the computation module 122 may allot an “Average” parameter score to the program for a performance parameter, the program can then be modified with regard to the performance parameter. In one implementation, details pertaining to the computation module 122 may be stored in the computation data 128.

In order to provide a better understanding and clarity of the present subject matter, table 1 illustrates an example of analysis of a program for the performance evaluation. The table 1 is provided to provide a better understanding of the present subject matter, and should not be construed as limiting.

TABLE 1

| | | | |
|---|---|---|---|
| SCORING CRITERIA | | | |
| PERTAINING TO EACH | PERFORMANCE | SCORE LEGEND | PARAMETER |
| PERFORMANCE PARAMETER | PARAMETERS | DESCRIPTION | SCORES |

LEADERSHIP CATEGORY (0-250)

| | | | |
|---|---|---|---|
| 1) Statement of Vision, | Are there Vision, Mission | 0—No review | 30 |
| Mission and Values (VMV) of | and Values (VMV) of the | conducted | |
| the program | program clearly defined, | 15—As per target (either | |
| 2) Evidence of VMV | communicated? Is the | at onsite or offshore) | |
| communicated and embedded | program VMV embedded in | 30—As per target (both | |
| in the culture and daily | the culture and daily | onsite and offshore) | |
| activities of program team | activities of program team | | |
| members both at onsite and | members? | | |
| offshore. | | | |
| Number of reviews held with | # of reviews held with | 0—No review | 30 |
| steering committee | steering committee | conducted | |
| | | 15—As per target (either | |
| | | at onsite or offshore) | |
| | | 30—As per target (both | |
| | | onsite and offshore) | |
| Net Operating Profit after Tax | NOPAT for the program | 10—Less than 20% | 70 |
| (NOPAT) for the program | (aggregate of all | 25—Within 20%-29% | |
| (aggregate of all | projects/engagements) | 35—As per target | |
| projects/engagements) | | 55—Above 30% and | |
| | | below 45% | |
| | | 70—Above 45% | |
| No. of Proactive Employee | No. of PEEP sessions | 0—No PEEP conducted | 15 |
| Engagement Program (PEEP) | conducted by Program | 5—As per target (either | |
| sessions conducted by | Manager/as applicable for | at onsite or offshore) | |
| Program Manager/as | onsite/offshore | 10—As per target (both | |
| applicable for onsite/offshore. | | onsite and offshore) | |
| | | 15—Beyond target (both | |
| | | at onsite and offshore as | |
| | | well) | |
| % of Associates' Goals that are | % of Associates' Goals that | 0—No goal setting | 25 |
| set for a predefined time | are set for a predefined time | process initiated | |
| period | period | 5—Below target (both | |
| | | onsite and offshore) | |
| | | 10—As per target (either | |
| | | at onsite or offshore) | |
| | | 25—As per target (both | |
| | | onsite and offshore) | |
| Number of awareness sessions | Number of awareness | 0—No session | 15 |
| conducted for Company Code | sessions conducted for | conducted | |
| Of Conduct (CCOC) by Local | CCOC by Local Ethics | 5—As per target (either | |
| Ethics Counselor/Program | Counselor/Program Manager | at onsite or offshore) | |
| Manager | | 15—As per target (both | |
| | | onsite and offshore) | |
| # of open/Work In Progress | # of open/WIP issues) | 0—Open/WIP issues | 40 |
| (WIP) issues | | exist | |
| | | 20—As per target (either | |
| | | at onsite or offshore) | |
| | | 40—As per target (both | |
| | | onsite and offshore) | |
| No. of Town hall/Open house | No. of Town hall/Open house | 0—No Town hall | 25 |
| meetings held | meetings held | meetings conducted | |
| | | 25—As per target | |
| | | Leadership Category | 250 |
| | | Score | |

STRATEGY AND PLANNING CATEGORY (0-250)

| | | | |
|---|---|---|---|
| Program Benefits Delivery: | Program Benefits Delivery | 20—for B1-B2 | 70 |
| percentage of benefits | | 30—for B3 | |
| delivered. | | 40—for B4 | |
| | | 50—for B5 | |
| | | 60—for B6 | |
| | | 70—For B7 and above | |
| Percentage—Integrated | Integrated program planning, | 0—Not available with | 40 |
| program planning, monitoring | monitoring and control | the Program team | |
| and control | Stakeholder expectations are | 10—Less than 60% | |
| Percentage—Stakeholder | managed effectively | 25—As per target | |
| expectations are managed | | 40—Between 61% and | |
| effectively | | 75% | |
| | | 50—Above 75% | |
| Utilization (for Time and | Utilization (for T&M and | 5—Less than 98% | 20 |
| Material (T&M) and Pseudo | Pseudo Turnkey | 10—As per target | |
| Turnkey Engagements) | Engagements) | 20—Above 98 and | |
| | | below 100% | |
| % of Projects in the program in | % of Projects in the program | 5—more than 10% | 20 |
| ‘Red’ status in the Review/ | in ‘Red’ status in the Review/ | 10—As per target | |
| Health Check | Health Check | 20—0% red projects | |
| No. of days outstanding | No. of days outstanding | 1—Beyond 70 days | 20 |
| [(outstanding divided by last | [(outstanding divided by last | 10—Within 46 days and | |
| 12 months billing) * 365] | 12 months billing) * 365] | 70 days | |
| | | 15—As per target | |
| | | 25—With in 44 days and | |
| | | 16 days | |
| Onsite realization of dollar rate | Onsite realization | 1—Less than $55/h | 20 |
| per hour | | 5—Within $56/h and | |
| | | $69/h | |
| | | 10—As per target | |
| | | 15—Within $71/h and | |
| | | $90/h | |
| | | 20—More than $90/h | |
| Offshore realization of dollar | Offshore realization | 1—Less than $20/h | 20 |
| rate per hour | | 5—Within $21/h and | |
| | | $24/h | |
| | | 10—As per target | |
| | | 15—Within $26/h and | |
| | | $30/h | |
| | | 20—More than $30/h | |
| Offshore Leverage (Offshore | Offshore Leverage (Offshore | 1—Less than 35% | 20 |
| revenue as % of total revenue) | revenue as % of total | 5—Within 36% and | |
| | revenue) | 44% | |
| | | 10—As per target | |
| | | 15—Within 46% and | |
| | | 55% | |
| | | 20—More than 55% | |
| Number of stakeholders: | Program Plan signed off by | 1—Program Plan signed | 20 |
| Program Plan signed off by all | all stakeholders | off by Delivery Head | |
| stakeholders | | (DH) responsible for the | |
| | | program | |
| | | 10—Signed off by DH | |
| | | & any one of | |
| | | stakeholders | |
| | | 20—Signed by all stake | |
| | | holders | |
| | | SP Category Score | 250 |

CUSTOMER & MARKET CATEGORY (0-150)

| | | | |
|---|---|---|---|
| Aggregate Customer | Aggregate CSI (%) for the | 10—Less than 80% | 50 |
| Satisfaction Index CSI (%) for | program (Need to include all | 20—Within 80%-89% | |
| the program (Need to include | projects in the program and | 35—As per target | |
| all projects in the program and | arrive at the aggregate) | 50—Above target | |
| arrive at the aggregate) | | | |
| No of customer red projects in | No of customer red projects | 0—Below target and | 30 |
| the program | in the program | more than 3 | |
| | | 15—Below target and up | |
| | | to 2 | |
| | | 30—As per target | |
| No of references | No of references | 0—No references | 20 |
| | | 10—As per target | |
| | | 20—Above target | |
| No. of customer complaints | No. of customer complaints | 0—More than Two | 30 |
| from the program escalated to | from the program escalated | complaints per quarter | |
| the Client Partner or Delivery | to the Client Partner or | 10—Two complaints per | |
| Head of the Relationship | Delivery Head of the | quarter | |
| | Relationship | 20—One compliant per | |
| | | quarter | |
| | | 30—No complaints | |
| No. of appreciation letters/e- | No. of appreciation letters/e- | 0—No letters received | 20 |
| mails received from customer | mails received from customer | 5—Between one | |
| as % of program team strength | as % of program team | letter/email and 4% | |
| | strength | 10—As per target | |
| | | 15—Within 6% and | |
| | | 10% | |
| | | 20—Above 10% | |
| | | CM Category Score | 150 |

MEASUREMENT, ANALYSIS & KNOWLEDGE
MANAGEMENT CATEGORY (0-100)

| | | | |
|---|---|---|---|
| No. of Score Card reviews | No. of Score Card reviews | 0—No review | 20 |
| done for the program | done for the program | conducted | |
| | | 10—As per target (either | |
| | | onsite or offshore) | |
| | | 20—As per target (both | |
| | | onsite and offshore) | |
| No. of tools | No. of tools | 0—No tools developed | 20 |
| developed/improvement | developed/improvement | 5—Below target | |
| initiatives undertaken in the | initiatives undertaken in the | 10—As per target | |
| program | program | 20—Above target | |
| No of KM (Knowledge | No of KM assets created | 0—No assets developed | 20 |
| Management) assets created | | 5—Below target | |
| | | 10—As per target | |
| | | 20—Above target | |
| No. of Best Practices (BP) | No. of Best Practices (BP) | 0—NO BP adopted | 20 |
| adopted in the program | adopted in the program | 5—Below target (both | |
| | | onsite and offshore) | |
| | | 10—As per target (both | |
| | | onsite and offshore) | |
| | | 20—Beyond target (both | |
| | | onsite and offshore) | |
| No. of Best Practices from the | No. of Best Practices from | 0—No BP shared | 20 |
| program shared within the | the program shared within | 5—Below target (both | |
| relationship or Industry | the relationship or ISU or | onsite and offshore) | |
| Solution Unit (ISU) or Branch | Branch | 10—As per target (both | |
| | | onsite and offshore) | |
| | | 20—Beyond target (both | |
| | | onsite and offshore) | |
| | | MAKM Category | 100 |
| | | Score | |

HUMAN RESOURCE CATEGORY (0-150)

| | | | |
|---|---|---|---|
| Associate Satisfaction (ASAT) | ASAT at program level (%) | 5—Less than 65% | 50 |
| at program level (%) | | 15—Between 66% and | |
| | | 79% | |
| | | 25—As per target | |
| | | 40—Between 81% and | |
| | | 85% | |
| | | 50—Above 85% | |
| Improvement Ideas logged in | Improvement Ideas logged in | 0—No PIPs | 20 |
| the company's system (% of | company's system (% of | 5—Below target (onsite | |
| associates in the program) | associates in the program) | and offshore) | |
| | | 10—As per target | |
| | | (onsite and offshore) | |
| | | 15—Between 11% and | |
| | | 15% (onsite and | |
| | | offshore) | |
| | | 20—Above 15% (onsite | |
| | | and offshore) | |
| % of associates that have one | % of associates that have one | 0—No certifications | 20 |
| or more professional or | or more professional or | 5—Below target | |
| technical certifications | technical certifications | 10—As per target | |
| | | 15—Between 16% and | |
| | | 20% | |
| | | 20—Above 20% | |
| Project Management | PMP or PRINCE2 | 0—No certification | 15 |
| Professional (PMP) or Projects | certification (% of Project | (both onsite and | |
| in controlled environment | Leaders or Project Managers | offshore) | |
| (PRINCE2) certification (% of | in the program) | 5—Below target (both | |
| Project Leaders or Project | | onsite and offshore) | |
| Managers in the program) | | 10—As per target (either | |
| | | onsite or offshore) | |
| | | 15—As per target (both | |
| | | onsite and offshore) | |
| Participation in Motivational | Participation in Motivational | 0—No participation | 15 |
| Initiative (% of associates in | Initiative (% of associates in | 5—Below target (onsite | |
| the program) | the program) | and offshore) | |
| | | 10—As per target | |
| | | (onsite and offshore) | |
| | | 15—Above target | |
| Attrition rate (associates | Attrition rate (associates | 0—Greater than 4% | 15 |
| leaving the organization from | leaving organization from the | 5—Between 1% and <3% | |
| the project teams in the | project teams in the program) | 10—Less 1% | |
| program) | | 15—0% | |
| Average Training days per | Average Training days per | 0—No training | 15 |
| associate in the program | associate in the program | 5—Less than target | |
| | | (onsite or offshore) | |
| | | 10—As per target | |
| | | (onsite and offshore) | |
| | | 15—Beyond target | |
| | | (onsite and offshore) | |
| | | HR Category Score | 150 |

PROCESS AND DELIVERABLES CATEGORY (0-100)

| | | | |
|---|---|---|---|
| % on-time delivery (for | % on-time delivery (for | 0—Less than 90% | 10 |
| Development projects in the | Development projects in the | 4—Between 90% and | |
| program) | program) | 96% | |
| | | 8—As per target | |
| | | 9—Above 97% and | |
| | | below 100% | |
| | | 10—100% | |
| % within budget delivery (for | % within budget delivery (for | 0—Less than 90% | 10 |
| Development projects in the | Development projects in the | 4—Between 90% and | |
| program) | program) | 96% | |
| | | 8—As per target | |
| | | 9—Above 97% and | |
| | | below 100% | |
| | | 10—100% | |
| % of total life cycle defects | % of total life cycle defects | 1—Greater than 5% | 10 |
| found during User Acceptance | found during UAT (for | 4—Between 3% and 5% | |
| Test—UAT (for Development | Development projects in the | 8—As per target | |
| projects in the program) | program) | 9—Up to 1% | |
| | | 10—0% | |
| % bad fixes (for Maintenance | % bad fixes (for Maintenance | 1—Greater than 2% | 10 |
| and Support projects in the | and Support projects in the | 5—Between 1% and 2% | |
| program) | program) | 8—Less than 1% | |
| | | 10—As per target | |
| Response Time Index (for | Response Time Index (for | 0—No Service-Level | 10 |
| Maintenance and Support | Maintenance and Support | Agreements (SLA) | |
| projects in the program) | projects in the program) | 4—Less than 90% SLA | |
| | | compliance | |
| | | 6—Between 90% and | |
| | | 99% SLA compliance | |
| | | 10—As per target | |
| % of Pure Turnkey and T&M | % of Pure Turnkey and T&M | 0—Less than the target | 10 |
| (projects>10 persons at onsite) | (projects>10 persons at | 10—As per target | |
| gone through the Project | onsite) gone through the | | |
| Management Risk | Project Management Risk | | |
| review/Health Check | review/Health Check | | |
| conducted for the program | conducted for the program | | |
| Program management tool | program management tool | 0—Less than 90% | 10 |
| Usage Index | Usage Index | 5—Between 90% and | |
| | | 95% | |
| | | 10—As per target | |
| Cost Of Quality (COQ) | COQ | 0—More than 30% | 10 |
| | | 5—Between 25% and | |
| | | 30% | |
| | | 10—As per target | |
| Percentage: | QMS Deployment Index | 0—Less than 90% | 10 |
| Quality Management System | | 5—Between 90% and | |
| (QMS) Deployment Index | | 95% | |
| | | 10—As per target | |
| Number of red projects in the | Number of red projects in the | 0—Even a single | 10 |
| program | program | project in ‘Red’ status | |
| | | 10—As per target | |
| | | PD Category Score | 100 |

As can be seen from the example illustrated in the table 1, an overall performance index of a program may be ascertained on a scale of 0-1000. In one implementation, for the leadership category, the computation module 122 may evaluate the performance of the program on a scale of 0-250. Similarly, for the SP category, the CM category, the MAKP category, the HR category and the PD category, the computation module 122 may evaluate the performance of the program on a scale of 0-250, 0-150, 0-100, 0-150 and 0-100, respectively. Further, the computation module 122 may allot a parameter score for a performance parameter on a scale of, e.g., 0-10, 0-30 or 0-45, based on a corresponding weight of the performance parameter. In one implementation, the scales for the analysis categories may vary based on nature of the program, industry the program belongs to, and user's preference. In one example, for different analysis categories, the program may be evaluated for the performance on the same scale. In another example, for different analysis categories, the scale for the performance evaluation may be different. In one implementation, the user may select the scales for each performance parameter or each analysis category. In another implementation, the computation module 122 may select the scales based on historical records and previous cycles of performance analysis of similar programs.

With reference to the example cited in the table 1, for a performance parameter “Number of reviews held with steering committee” of the leadership category, the computation module 122 may allot a parameter score of 0, 15 or 30 to the program. For example, based on the information of the program pertaining to the performance parameter, if the computation module 122 may determine that a review is not conducted, the computation module 122 may allot a parameter score of “0” to the program. On the other hand, if the computation module 122 may determine that a predefined number of reviews have been conducted onsite as well as offsite, the computation module 122 may allot a parameter score of “30” to the program. Similarly, the computation module 122 may allot parameter scores corresponding to other performance parameters of the leadership category, and subsequently, may consolidate the parameter scores to compute a leadership category score for the program. Similarly, the computation module 122 may allot parameter scores to rest of the performance parameters corresponding to the SP category, the CM category, the MAKM category, the HR category and the PD category.

Following the determination of the parameter scores, the computation module 122 may determine the SP category score, the CM category score, the MAKM category score, the HR category score and the PD category score for the program. The computation module 122 may further consolidate the leadership category score, the SP category score, the CM category score, the MAKM category score, the HR category score and the PD category score to ascertain an overall performance index for the program. Continuing with the present example, in case the computation module 122 determines an overall performance index of 0-450, the execution, performance and implementation of the program can be considered as “Poor”. Similarly, if the overall performance index lies in a range of 451-750, the program can be considered as “Average”. On the other hand, if the overall performance index lies in a range of 751-1000, the program can be considered as “Good”.

Further, as mentioned previously, the computation module 122 may generate a performance evaluation report providing a detailed analysis of the performance evaluation of the program, and on the basis of the performance evaluation report, the program can be accordingly updated to improve the overall performance.

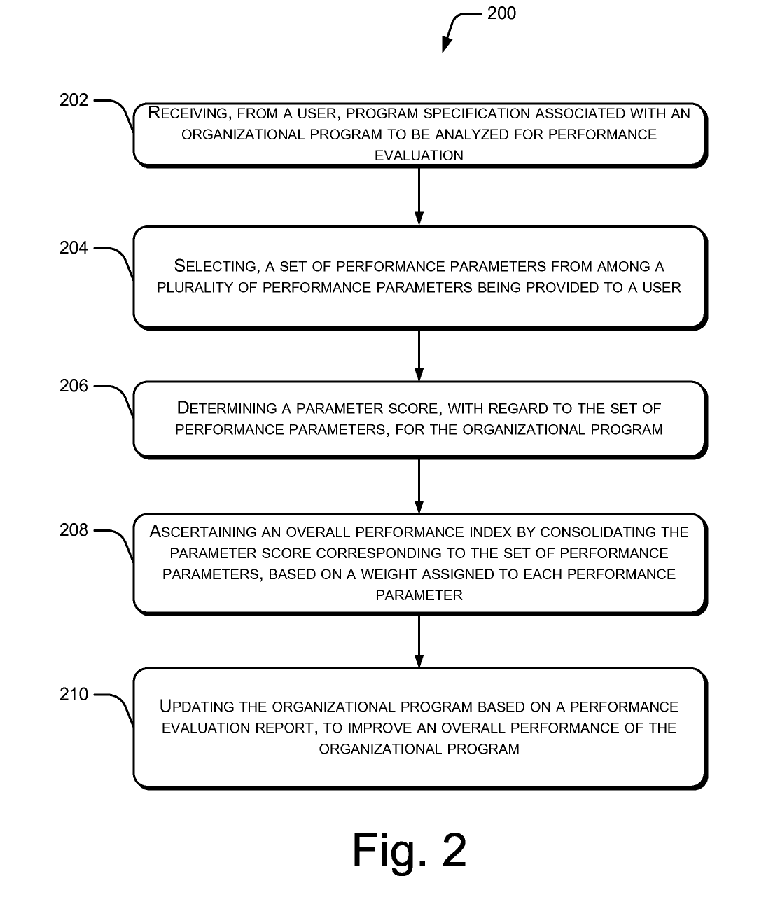

FIG. 2 illustrates a method 200 for a parameter-based performance analysis of a program, interchangeably referred to as organizational program, according to one embodiment of the present subject matter. The method 200 may be implemented in a variety of computing systems in several different ways. For example, the method 200, described herein, may be implemented using a performance evaluation system 102, as described above.

The method 200, completely or partially, may be described in the general context of computer executable instructions. Generally, computer executable instructions can include routines, programs, objects, components, data structures, procedures, modules, functions, etc., that perform particular functions or implement particular abstract data types. A person skilled in the art will readily recognize that steps of the method can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of the described method 200.

The order in which the method 200 is described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the methods can be implemented in any suitable hardware, software, firmware, or combination thereof. It will be understood that even though the method 200 is described with reference to the system 102, the description may be extended to other systems as well.

With reference to the description of FIG. 2, for the sake of brevity, the details of the components of the performance evaluation system 102 are not discussed here. Such details can be understood as provided in the description provided with reference to FIG. 1.

The method 200 may provide a parameter-based performance analysis of a program. At block 202, program specification associated with a program to be analyzed for the performance evaluation may be received. In one implementation, the performance parameter module 120 of the performance evaluation system 102 may receive the program specification.

Following the receipt of the program, at block 204, a set of performance parameters may be selected from among a plurality of performance parameters being provided to a user. In one implementation, the plurality of performance parameters may be provided to the user for selecting the set of performance parameters based on which, the user wishes to analyze the program for the performance evaluation. The plurality of performance parameters may be categorized into at least one of a leadership category, a Strategy and Planning (SP) category, a Customer and Market (CM) category, a Measurement Analysis and Knowledge Management (MAKM) category, a Human Resource (HR) category and a Process and Deliverables (PD) category. In one implementation, the performance parameter module 120 of the performance evaluation system 102 may obtain the set of performance parameters from among the plurality of performance parameters being provided to the user.

At block 206, a parameter score, with regard to the set of performance parameters, may be determined for the program. In one implementation, a parameter score may be determined based on scoring criteria of the program pertaining to the corresponding performance parameter. The scoring criteria may be understood as information of the program pertaining to the corresponding performance parameter. Further, the parameter scores may be combined to compute a category score. For example, parameter scores corresponding to performance parameters of the leadership category may be combined to determine the leadership category score for the program. Similarly, the SP category score, the CM category score, the MAKM category score, the HR category score and the PD category score can be determined. In one implementation, the computation module 122 of the performance evaluation system 102 may determine the parameter scores for the program.

At block 208, the parameter scores or the category scores may be consolidated to ascertain an overall performance index, based on a weight assigned to each of the plurality of performance parameters or the analysis categories. A weight of a performance parameter or an analysis category is indicative of weightage of the performance parameter or the analysis category for the ascertaining of an overall performance index of a program. Subsequent to the ascertaining of the overall performance index, a performance evaluation report may be generated. The performance evaluation report may include, but is not limited to the parameter scores, the category scores, the overall performance index, areas of improvement and suggestions to improve an overall performance of the program. In one implementation, the computation module 122 of the performance evaluation system 102 may ascertain an overall performance index for a program.

At block 210, the program may be updated based on the performance evaluation report. In one implementation, an administrator may update the program. The administrator may be understood as a person being provided with the authority of taking managerial decisions for the program.

Although implementations of a method for a parameter-based performance analysis of a program have been described in language specific to structural features and/or methods, it is to be understood that the present subject matter is not necessarily limited to the specific features or methods described.

I/we claim:

1. A method for a parameter-based performance analysis of an organizational program, the method comprising:
receiving, by a processor, program specification associated with the organizational program to be analyzed for performance evaluation, wherein the program specification is indicative of functional and operational characteristics of the organizational program;
selecting, a set of performance parameters for the performance evaluation, from among a plurality of performance parameters being provided to a user, wherein the plurality of performance parameters pertain to an analysis category, the analysis category being indicative of at least one of leadership, strategy, planning, customer, market research, knowledge management, human resource, and deliverables associated with the organizational program;
determining, by the processor, a parameter score for each of the set of performance parameters, wherein the parameter score is determined based on a pre-defined scoring criteria of the organizational program pertaining to each of the set of performance parameters;
ascertaining, by the processor, an overall performance index for the organizational program by consolidating the parameter score corresponding to each of the set of performance parameters, based on a weight assigned to each of the set of performance parameters, wherein the weight assigned to each performance parameter is indicative of a weightage of the performance parameter in the ascertaining of the overall performance index; and
generating, by the processor, a performance evaluation report, wherein the performance evaluation report includes at least one of the parameter score, the overall performance index, at least one area of improvement, and at least one suggestion for updating the organizational program.

2. The method as claimed in claim 1, wherein the analysis category includes at least one of a leadership category, a Strategic Planning (SP) category, a Customer and Market (CM) category, a Measurement Analysis and Knowledge Management (MAKM) category, a Human Resource (HR) category and a Process and Deliverables (PD) category.

3. The method as claimed in claim 2, further comprising:
determining, by the processor, a category score for each of the leadership category, the SP category, the CM category, the MAKM category, the HR category, and the PD category, by consolidating the parameter score corresponding to each of the set of performance parameters, based on the weight assigned to each performance parameter; and
ascertaining, by the processor, the overall performance index for the organizational program by consolidating the category scores, based on a weight assigned to each of the leadership category, the SP category, the CM category, the MAKM category, the HR category, and the PD category.

4. The method as claimed in claim 1, wherein the pre-defined scoring criteria is indicative of available information of the organizational program pertaining to each of the set of performance parameters.

5. The method as claimed in claim 1, wherein the program specification includes at least one of timelines, milestones, objectives, statistics, resources, and field of the organizational program

6. A performance analysis system for evaluating performance of an organizational program, the performance analysis system comprising:
a processor;
a performance parameter module, coupled to the processor, to,
receive program specification associated with the organizational program to be analyzed for performance evaluation, wherein the program specification is indicative of operational and functional characteristics of the organizational program;
select a set of performance parameters for the performance evaluation, from among a plurality of performance parameters being provided to a user, wherein the plurality of performance parameters pertain to an analysis category, the analysis category being indicative of at least one of leadership, strategy, planning, a customer, market research, knowledge management, human resource and deliverables associated with the organizational program;
and
a computation module, coupled to the processor, to,
determine a parameter score for each of the set of performance parameters, wherein the parameter score is determined based on a pre-defined scoring criteria of the organizational program pertaining to each of the set of performance parameters;
ascertain an overall performance index for the organizational program by consolidating the parameter score corresponding to each of the set of performance parameters, based on a weight assigned to each of the set of performance parameters, wherein the weight assigned to each performance parameter is indicative of a weightage of the performance parameter in the ascertaining of the overall performance index; and
generate a performance evaluation report, wherein the performance evaluation report includes at least one of the parameter score, the overall performance index, at least one area of improvement, and at least one suggestion for updating the organizational program.

7. The performance analysis system as claimed in claim 6, wherein the analysis category includes at least one of a leadership category, a Strategic Planning (SP) category, a Customer and Market (CM) category, a Measurement Analysis and Knowledge Management (MAKM) category, a Human Resource (HR) category and a Process and Deliverables (PD) category.

8. The performance analysis system as claimed in claim 7, wherein the computation module,
determines a category score for each of the leadership category, the SP category, the CM category, the MAKM category, the HR category, and the PD category, by consolidating the parameter score corresponding to each of the set of performance parameters, based on the weight assigned to each performance parameter; and
ascertains the overall performance index for the organizational program by consolidating the category scores, based on a weight assigned to each of the leadership category, the SP category, the CM category, the MAKM category, the HR category, and the PD category.

9. The performance analysis system as claimed in claim 6, wherein the pre-defined scoring criteria is indicative of available information of the organizational program pertaining to each of the set of performance parameters.

10. The performance analysis system as claimed in claim 6, wherein the program specification includes at least one of timelines, milestones, objectives, statistics, resources and field of the organizational program.

11. A non-transitory computer-readable medium having embodied thereon a computer program for executing a method comprising:
receiving, by a processor, program specification associated with an organizational program to be analyzed for performance evaluation, wherein the program specification is indicative of operational and functional characteristics of the organizational program;
selecting, a set of performance parameters for the performance evaluation, from among a plurality of performance parameters being provided to a user, wherein the plurality of performance parameters pertain to an analysis category, the analysis category being indicative of at least one of leadership, strategy, planning, customer, market research, knowledge management, human resource and deliverables associated with the organizational program;
determining, by the processor, a parameter score for each of the set of performance parameters, wherein the parameter score is determined based on a pre-defined scoring criteria of the organizational program pertaining to each of the set of performance parameters;
ascertaining, by the processor, an overall performance index for the organizational program by consolidating the parameter score corresponding to each of the set of performance parameters, based on a weight assigned to each of the set of performance parameters, wherein the weight assigned to each performance parameter is indicative of a weightage of the performance parameter in the ascertaining of the overall performance index; and
generating, by the processor, a performance evaluation report, wherein the performance evaluation report includes at least one of the parameter score, the overall performance index, at least one area of improvement, and at least one suggestion to for updating, the organizational program.
